(19) United States
(12) Patent Application Publication
(10) Pub. No.: US 2007/0188452 A1
(43) Pub. Date: Aug. 16, 2007

(54) INPUT DEVICE FOR COMPUTER

(75) Inventors: HSUAN-CHEN CHEN, Tu-Cheng (TW); LIN-YUN HONG, Shenzhen (CN); CHIEN-LI TSAI, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,765

(22) Filed: Sep. 22, 2006

(30) Foreign Application Priority Data
Feb. 10, 2006 (CN) 200620054939.7

(51) Int. Cl. G09G 5/08

(52) U.S. Cl. 345/163

(57) ABSTRACT

An input device includes a mouse unit, a keyboard unit, and two covers. The mouse unit includes two spaced mounting portions arranged on a front end thereof, the keyboard unit is mounted on the mouse unit at rear of the mouse unit, and the covers are pivotally attached to the mounting portions respectively for covering the keyboard unit.

### 1. FIELD OF THE INVENTION

The present invention relates to an input device, and more particularly to an input device for a computer which is a combination of a mouse and a keyboard.

### 2. DESCRIPTION OF RELATED ART

Input devices for desktop computers and other electronic equipment generally include a mouse and a keyboard. The mouse is used to control movement of the cursor and selection of functions on a computer display. The keyboard is used to input text to a computer. However, it is cumbersome and inconvenient for an operator to move his hand between the keyboard and the mouse to fulfill different tasks.

To address aforementioned problem, Taiwan Patent No. 258804 discloses an input device combining a mouse with a numeric keypad, which includes a main body for carrying out a function of a typical mouse, and a numeric keypad disposed on the main body for carrying out a function of numeric input. However, the keypad is exposed, dust easily covers and enters the main body, thereby damaging internal electronic components of the input device. Furthermore, it is uncomfortable for an operator to directly grasp the keypad when using the input device as a typical mouse.

What is needed, therefore, is a multifunction input device which may be operated comfortably, and is protected from dust.

### SUMMARY OF THE INVENTION

An exemplary input device includes a mouse unit, a keyboard unit, and two covers. The mouse unit includes two spaced mounting portions arranged on a front end thereof, the keyboard unit is mounted on the mouse unit at rear of the mouse unit, and the covers are pivotally attached to the mounting portions respectively for covering the keyboard unit.

Other advantages and novel features will become more apparent from the following detailed description of a preferred embodiment when taken in conjunction with the accompanying drawings, in which:

### BRIEF DESCRIPTION OF THE DRAWINGS

FIG. 1 is an exploded, partially sectioned isometric view of an input device in accordance with a preferred embodiment of the present invention, the input device including two covers;

FIG. 2 is an enlarged isometric view of a circled portion 11 of FIG. 1;

FIG. 3 is another aspect view of one cover of FIG. 1;

FIG. 4 is an assembled view of FIG. 1; and

FIG. 5 is similar to FIG. 4, but showing another state.

### DETAILED DESCRIPTION OF THE INVENTION

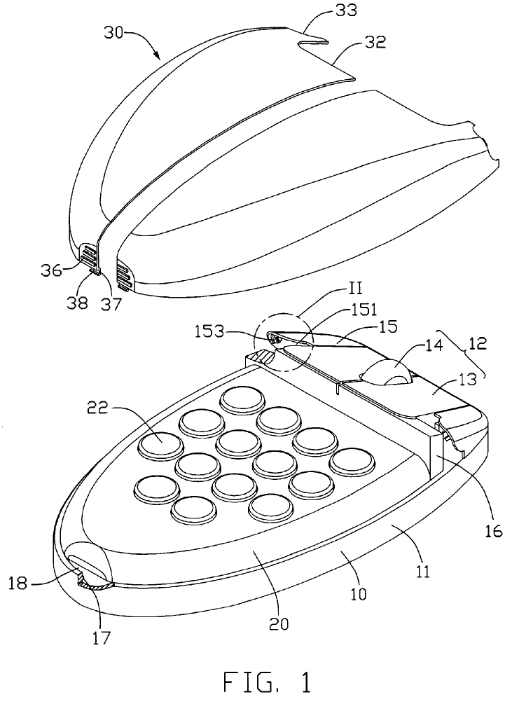

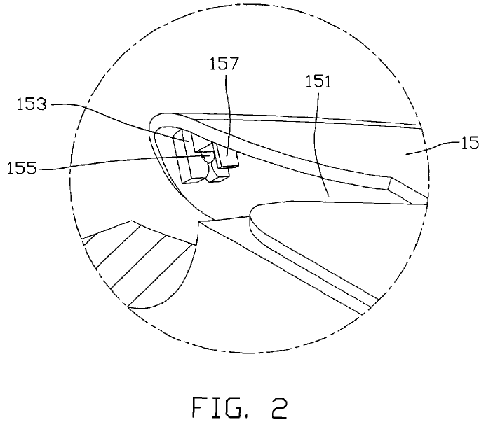

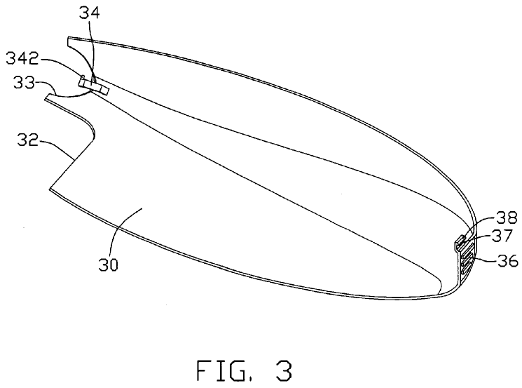

Referring to FIGS. 1 to 3, an input device is provided in accordance with a preferred embodiment of the present invention. The input device includes a mouse unit 10 functioning as a first input unit, a keyboard unit 20 functioning as a second input unit, and two symmetrical covers 30.

The mouse unit 10 includes a base 11, and a fixing plate 16 formed on the base 11 adjacent to a front rim of the base 11. An operating portion 12 is formed between the fixing plate 16 and the front rim of the base 11. Two spaced buttons 13 are mounted on the operating portion 12, and a scroll wheel 14 is mounted between the buttons 13. Two curved mounting portions 15 are formed adjacent to two sides of the operating portion 12 respectively, and a gap 151 is defined between each mounting portion 15 and the fixing plate 16. A support plate 153 slantingly extends down from an inside corner of each mounting portion 15, and a through hole 155 is defined in the support plate 153 by cutting out an end portion thereof, the through hole 155 including an entrance portion and a pivot portion. A generally L-shaped stop plate 157 is formed on the inside corner of each mounting portion 15 adjacent to the corresponding support plate 153. A block 17 is formed on an inside surface of a rear rim of the base 11.

The keyboard unit 20 is installed in the mouse unit 10 between the fixing plate 16 and the rear rim of the base 11. The keyboard unit 20 is electrically connected with the mouse unit 10, and a plurality of numeric keys 22 is installed on a top surface of the keyboard unit 20. A front edge of the keyboard unit 20 engages with the fixing plate 16, and a receiving hole 18 is defined between a rear edge of the keyboard unit 20 and the rear rim of the base 11.

The covers 30 cooperatively cover the keyboard unit 20. A front portion of each cover 30 defines an L-shaped opening 32 corresponding to the operating portion 12. A generally U-shaped cutout 33 is defined in a front corner of each cover 30 to engage with the corresponding mounting portion 15 of the mouse unit 10. A post 34 is formed extending from an inside corner of each cover 30, and protrudes out from the corresponding cutout 33. A pivot 342 extends perpendicularly from a free end of each post 34 toward a sidewall of the corresponding cover 30. A pressing portion 36 is formed on a rear portion of each cover 30, and a hook 37 protrudes down from the pressing portion 36. The hook 37 includes a hooking portion 38 extending out therefrom.

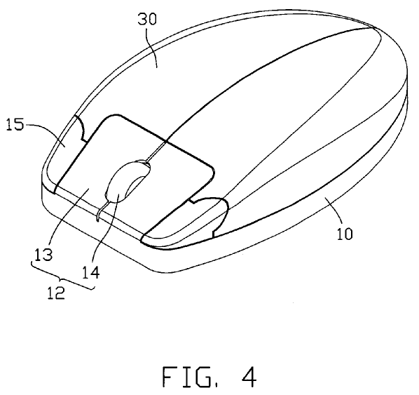

Referring also to FIG. 4, in assembly, the pivots 342 of the covers 30 are pressed into the pivot portions of the through holes 155 of the support plates 153 of the mounting portions 15 via the entrance portions respectively, and the posts 34 are sandwiched between the support plates 153 and the stop plates 157 of the mounting portions 15 respectively. Thereby, the covers 30 are pivotally attached to the mouse unit 10.

The covers 30 are pivoted to cover the keyboard unit 20 when the keyboard unit 20 is not in use, until the hooks 37 of the covers 30 enter the receiving hole 155 between the keyboard unit 20 and the mouse unit 10. The hooking portions 38 of the hooks 37 engage the block 17 of the rear rim of the base 11 of the mouse unit 10, thereby the covers 30 are locked to the mouse unit 10. The keyboard unit 20 is covered, and the buttons 13 and the scroll wheel 14 on the operating portion 12 are exposed. In this state, the input device is used as a mouse. The covers 30 cover the keyboard unit 20 to protect the keyboard unit 20 from dust, and the covers 30 as a contact surface is comfortable for a user to hold.

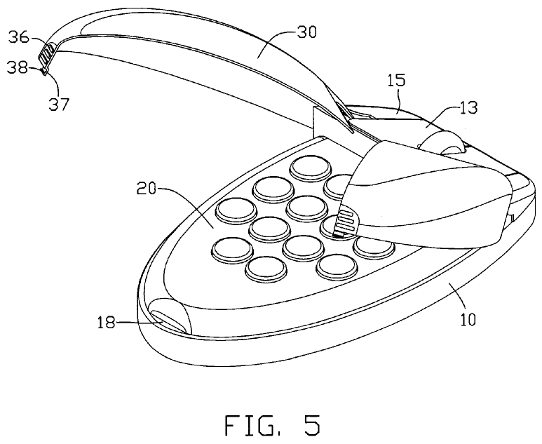

Referring also to FIG. 5, when there is a need to use the keyboard unit 20 of the input device, the pressing portions 36 of the covers 30 are pressed, the hooking portions 38 disengage from the block 17 of the mouse unit 10, and the covers 30 are unlocked. After that, the covers 30 are rotated upward, the covers 30 are spaced apart from each other in generally opposite directions, the covers 30 are thus swung open. The keyboard unit 20 is exposed, and the user can operate the keyboard unit 20 by pressing the keys 22 thereof.

It is believed that the present embodiment and its advantages will be understood from the foregoing description, and it will be apparent that various changes may be made thereto without departing from the spirit and scope of the invention or sacrificing all of its material advantages, the example hereinbefore described merely being preferred or exemplary embodiment of the invention.

What is claimed is:

1. An input device comprising:
a mouse unit comprising two spaced mounting portions arranged on a front end thereof;
a keyboard unit mounted on the mouse unit at rear of the mouse unit; and
two covers pivotally attached to the mounting portions respectively for covering the keyboard unit.

2. The input device as claimed in claim 1, wherein each of the covers defines an opening, and two buttons and a scroll wheel are mounted on the mouse unit receivable in the openings.

3. The input device as claimed in claim 1, wherein each of the mounting portions forms a support plate, a through hole is defined in the support plate, each of the covers comprises a pivot for extending through the corresponding through hole and mounting a corresponding cover to the mouse unit.

4. The input device as claimed in claim 3, wherein two posts protrude from inside surfaces of the covers respectively, and the pivots extend from free ends of the posts respectively.

5. The input device as claimed in claim 4, wherein a stop plate is formed adjacent to each of the support plates, and each of the posts is sandwiched between the corresponding stop plate and the corresponding support plate.

6. The input device as claimed in claim 5, wherein each of the stop plates is generally L-shaped.

7. The input device as claimed in claim 1, wherein at least one block is formed on an inside surface of a rear end of the mouse unit, each of the covers form a pressing portion, and a hook extends from the pressing portion for engaging with the block.

8. The input device as claimed in claim 7, wherein a receiving hole is defined between the keyboard unit and the block of the mouse unit.

9. An input device comprising:
a first input unit;
a second input unit combined with the first input unit; and
two covers pivotally connectable with the first input unit and movable between a first position in which the covers shield the second input unit and a second position in which the covers are disposed substantially beside and above the second input unit.

10. The input device as claimed in claim 9, wherein each of the covers defines an opening, and two buttons and a scroll wheel are mounted on the first input unit receivable in the openings.

11. The input device as claimed in claim 9, wherein two support plates are arranged on a front end of the first input unit, a through hole is defined each of the support plates, each of the covers comprises a pivot for extending through the corresponding through hole and mounting a corresponding cover to the first input unit.

12. The input device as claimed in claim 11, wherein two posts protrude from inside surfaces of the covers respectively, and the pivots extend from free ends of the posts respectively.

13. The input device as claimed in claim 12, wherein a stop plate is formed adjacent to each of the support plates, and each of the posts is sandwiched between the corresponding stop plate and the corresponding support plate.

14. The input device as claimed in claim 9, wherein a receiving hole is defined between the second input unit and the first input unit, at least one block is formed on an inside surface of a rear end of the first input unit adjoining the receiving hole, each of the covers form a pressing portion, and a hook extends from the pressing portion for engaging with the block.

15. An input device comprising:
a mouse unit including a base and an operating portion arranged at a front end section of the base;
a keyboard unit arranged on the base adjacent the operating portion; and
a cover unit attached to the mouse unit in a manner such that the cover is movable between a first position in which the cover unit shields the keyboard unit and is configured for grasp of input device, and a second position in which the keyboard unit is exposed for operation.

16. The input device of claim 15, wherein the cover unit includes two covers, each cover includes a front cover end pivotably mounted to the front end section of the base, and a rear cover end engagable with a rear end section of the base for releasably locking the covers in the second position.

17. The input device of claim 16, wherein the rear cover ends get together when the covers are in the second position, and diverge when the covers are in the first position.
